(19) United States
(12) Patent Application Publication
(10) Pub. No.: US 2005/0045097 A1
(43) Pub. Date: Mar. 3, 2005

(54) Dip coating apparatus

(75) Inventors: Angelo J. Suitor, Saint Paul, MN (US); Mikhail L. Pekurovsky, Bloomington, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/650,498

(22) Filed: Aug. 28, 2003

(51) Int. Cl. B05C 3/00; B05C 3/09

(52) U.S. Cl. 118/429; 118/400; 118/500

(57) ABSTRACT

The present invention includes an apparatus for coating a workpiece with a coating solution. The apparatus includes a coating chamber in which the workpiece is coated, and a deformable coating solution supply container for supplying coating solution to the coating chamber. The coating chamber and a deformable coating solution supply container are fluidly connected such that the coating solution is flowable between the coating chamber and a deformable coating solution supply container.

### BACKGROUND OF THE INVENTION

The present invention relates to a coating apparatus and more particularly to a dip coating apparatus for applying a coating to a workpiece.

Protective coatings are applied to surfaces by various coating techniques. One of the more common techniques in commercial operations is dip coating. Dip coating comprises submerging the article to be coated in a coating solution, then either withdrawing the coating article from the solution or withdrawing the solution away from the coating article. This type of process is particularly suited for commercial operations that require complete and rapid coating of the workpiece. Both dip coating techniques leave a thin layer of solution on the surface of the workpiece that dries to a desired coating layer.

General dip coating is also discussed in U.S. Pat. Nos. 3,421,477 and 5,720,815. A general review of dip coating is found in Free-Meniscus Coating Processes by Schunk, Hurd and Brinker (1997, Liquid Film Coating, eds Kistler and Schweizer, Chapman & Hall), Fundamentals of dip coating by withdrawal is discussed in Deryagin and Levi (1964, Film Coating Theory, London: Focal Press), and Scriven (1988, Physics and application of dip coating and spin coating). Coating by drainage is studied in Jeffreys (1930, Draining of a vertical plate. Proc. Camb. Phil. Soc. 26:204-205), Van Rossum (1958, Viscous lifting and drainage of liquid. Appl. Sci. Res. A. 7:121-144), and Groenveld (1971, Drainage and withdrawal of liquid films. AIChE J. 17:489-490).

One method of particular interest is a coating chamber in which the workpiece to be coated remains stationery while the coating chamber is filled with the coating solution. The coating solution is then removed from the coating chamber by gravity, that is, the solution is permitted to drain from the coating chamber. Such a system when coating multiple workpieces requires a number of cycles of filling and emptying the coating chamber as well as placement and removal of the workpieces. Several manufacturers presently offer commercial dip coating machines that rely on gravity to drain coating solution from the coating chamber, thus depositing a coating layer on the workpiece. One commercial example is the SJT Disk Luber of Intevac, Inc. of Santa Clara, Calif., which deposits a thin film of lubricant onto magnetic disks. Improved coating uniformity is claimed due to the absence of mechanical vibrations during the coating process. WO2001/38005A describes an apparatus that deposits layers of UV varnish onto optical lenses using gravity-driven drainage to remove the coating solution from the coating chamber.

One concern in dip coating is the use of solvents in the coating solution. Solvents used in dip coating processes are often volatile and require special attention to minimize solvent loss due to evaporation. Multiple cycles of filling and emptying the coating chamber and the holding tank add to solvent loss. One solution that has been used to minimize solvent loss is the use of chill tanks to reduce the temperature of the solvent thereby minimizing evaporation. In addition, sealing of either the coating solution holding tank or the coating chamber during coating or both have also been attempted. However, such seals have not eliminated coating solution loss.

### BRIEF SUMMARY OF THE INVENTION

The present invention includes an apparatus for coating a workpiece with a coating solution. The apparatus includes a coating chamber in which the workpiece is coated, and a deformable coating solution supply container for supplying coating solution to the coating chamber. The coating chamber and the deformable coating solution supply container are fluidly connected such that the coating solution is flowable between the coating chamber and the deformable coating solution supply container. Deformation of the coating solution supply container forces the coating solution into the coating chamber.

### BRIEF DESCRIPTION OF THE FIGURES

FIG. 1 is a diagrammical view of the apparatus of the present invention.

FIG. 2 is a diagrammical view of another embodiment of the present invention.

FIG. 3 is a diagrammical view of yet another embodiment of the present invention.

FIG. 4 is a graphical view of the results of abrasion studies.

### DETAILED DESCRIPTION

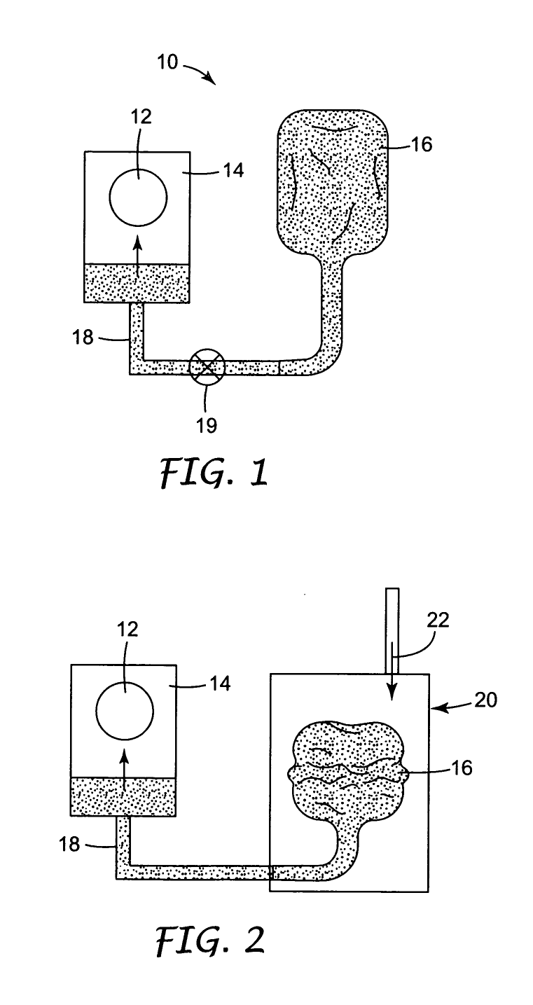

The apparatus of the present invention is generally illustrated as apparatus 10 in FIG. 1. The apparatus 10 is used to provide a protective coating to workpieces 12 by a dip coating technique. The apparatus 10 provides a uniform coating in an appropriate coating weight while minimizing evaporative loss of the coating solution. The apparatus is especially useful in coating small batches of workpieces. The apparatus is inexpensive when compared to prior art dip coating devices.

The apparatus 10 generally comprises a coating chamber 14, and a coating solution supply container 16. The coating chamber 14 and the coating solution supply container 16 are fluidly connected by a fluid connection 18. The present invention can take the form of several embodiments that are described below and illustrated in the Figures wherein like reference characters will be used to identify like elements.

One embodiment of the present invention includes the coating solution supply container 16 in the form of a deformable bag as illustrated in FIG. 1. The supply container 16 may be a hermetically sealed deformable bag made of a flexible material. By hermetically sealed it is meant that water, air and other contaminants are kept from the coating solution due to the hermetic seal.

Many coating solutions are solvent based. Such coating solutions comprise a coating composition and solvent. If the coating solution is left in the coating solution supply container for an extended period of time, and the supply container is open to the environment or permits air to flow in and/or out, loss of solvent will occur. Loss of solvent is detrimental environmentally and costly.

Solvents and the coating composition are also generally harmful to humans. Exposure to solvents and the coating composition by inhalation or skin contact can cause irritation within the respiratory tract or can cause skin to become irritated and/or inflamed. Solvents and the coating composition can also cause eye irritation. Preventing or minimizing exposure is the best way to avoid the harmful effects of exposure. Hermetically sealing the coating solution prevents exposure.

Additionally, many coating solutions react with oxygen and/or moisture. Hermetically sealing the coating solution supply container not only eliminates evaporative losses but also avoids “aging” of the solution due to reaction with oxygen or moisture. By hermetic seal is meant a seal that prevents entry of air into the supply container. A Ziploc®-type closure may also be included in the coating solution supply container. The Ziploc®-type closure is used to fill and refill the supply container with coating solution while being sufficiently tight to prevent air or moisture from entering the supply container.

The supply container 16 has walls that are sufficiently flexible to make the bag deformable or collapsible. By collapsible is meant that the walls of the bag are flexible enough that the walls may be squeezed manually, and therefore in a sense collapse the bag. The walls of the bag are also deformable since the walls are sufficiently flexible that when manually squeezed, the walls become deformed. In both instances, whether collapsible or deformable, since the container is sealed, when the bag is squeezed, the volume of the bag is reduced and coating solution is forced out.

Many types of polymers, all well known in the art, can provide deformable or collapsible characteristics to the walls of the bag. For example, polymers such as polyethylene, polypropylene, polyester, polyurethane, and others when used to form a bag provide sufficient flexibility so that the walls of the bag may either be collapsed or deformed when squeezed.

Reducing the volume of the container, forces the coating solution to flow out of the supply container 16 through the fluid connection 18 to the coating chamber 14. The fluid connection includes tubing, preferably flexible, connecting the supply container 16, containing coating solution, with the coating chamber 14. Alternatively, the supply container 16 may be fluidly connected by direct attachment to the coating chamber.

The coating solution supply container 16 may be squeezed in any of a number of ways. For example, the container may be squeezed manually. When using the apparatus, the coating solution supply container 16 may be squeezed manually using both hands or may be manually squeezed by placing the bag on a surface such as a table top (not shown) and pushing manually against the wall of the bag and against the table top. The force supplied by the manual squeezing pushes the coating solution through the fluid connection 18 into the coating chamber 14.

The coating supply container 16 may also be squeezed by fluid pressure as illustrated in FIG. 2. The supply container 16 is placed in a chamber 20 in which air or other fluid under pressure is supplied as indicated by arrow 22. The chamber 20 is non-expandable such that the fluid pressure 22 introduced into the chamber 20 acts on the exterior of the supply container 16, collapsing and/or deforming the container and thereby providing the force that results in coating solution flowing from the coating solution supply container 16 through the fluid connection 18 and into the coating chamber 14.

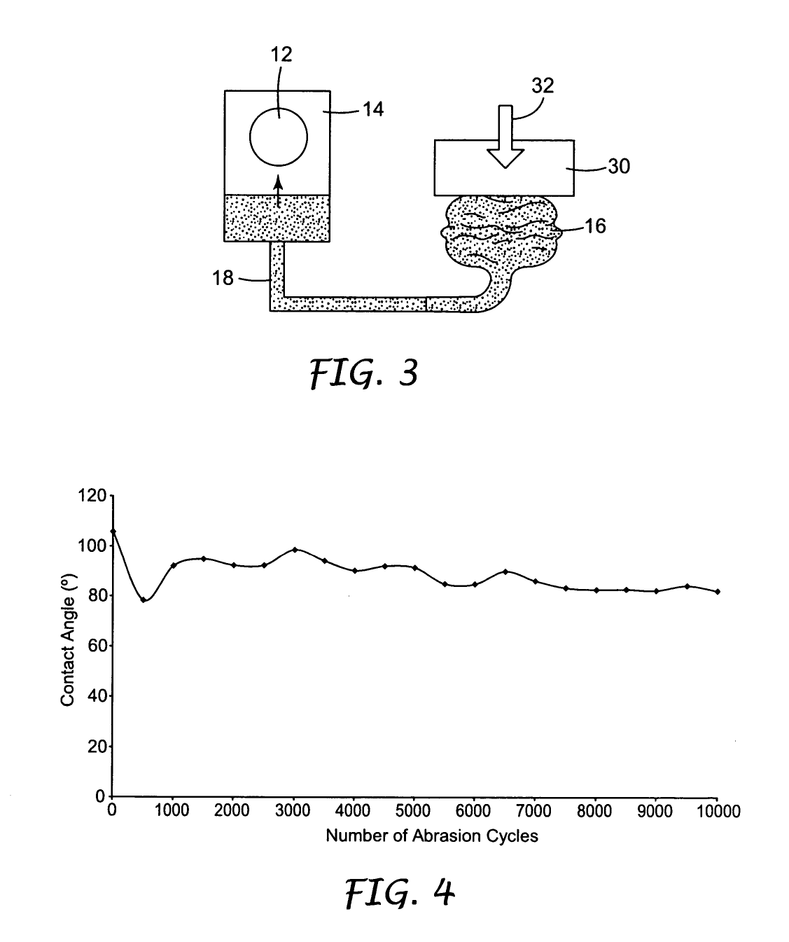

Alternatively, as illustrated in FIG. 3, the supply container 16 may be acted upon by a mechanical device such as a hydraulically actuated cylinder 30 that compresses the supply container 16 as indicated by arrow 32. By compressing the supply container 16, the container 16 is squeezed thereby collapsing and/or deforming the supply container 16 and forcing the coating solution through the fluid connection 18 and into the coating chamber.

The coating chamber 14 is of a size and shape suitable for the workpieces to be coated. In the example of ophthalmic lenses, the coating chamber need not necessarily be very large if only one lens is being coated at a time. A larger chamber may be needed to coat a greater number of lenses. The coating chamber may be constructed of rigid walls or it may be constructed of flexible or deformable walls of the same type as the supply container 16. A further advantage of having a deformable coating chamber is that during the coating procedure the system may be completely sealed to avoid the escape of and/or contamination of solvent.

Each of the embodiments may optionally include a further fluid conduit (not shown) for equalizing the gas pressure between the coating chamber 14 and the chamber 20. The fluid conduit advantageously includes a valve, which may be closed as pressure is imparted to chamber 20, then opened to allow the gas pressure in coating chamber 14 to equilibrate.

The workpiece may be optionally held in the coating chamber by a workpiece holder (not shown). The workpiece holder may be configured to hold the workpiece such that the area to be coated does not come in contact with the holder. For example, an ophthalmic lense requires a smooth coating on the lens area used for viewing. The ophthalmic lens is therefore held along its outer edge as much as possible so that the holder does not disrupt the coating and that the coating on the lens area dries to a smooth finish. Also the holder needs to be made of a material that does not react with the coating solution.

In use, a workpiece to be coated such as a lens is placed in the coating chamber 14. The coating chamber 14 is then sealed or covered, depending on its construction, and the coating solution is transported to the coating chamber by deforming or collapsing the walls of the coating solution supply container 16. A sufficient amount of solution is forced in the coating chamber to cover the workpiece 12. The coating solution is then permitted to flow back into the coating solution supply container 16 by gravitational forces.

A valve 19 such as a needle valve may be positioned within the fluid connection 18 and is placed in an open position to permit coating solution to flow into the coating chamber 14. The valve is closed for retaining the coating solution in the coating chamber and drainage of the coating chamber can be controlled by operation of the needle valve.

To facilitate the flow of coating solution from the coating chamber 14 back to the coating solution supply container 16, the coating chamber 14 may be placed in an elevated position with respect to the coating solution supply container 16. It will be appreciated, that such positioning facilitates gravitation flow of the coating solution back to the supply container 16. Likewise, to facilitate flow of the coating solution to the coating chamber, the coating solution supply container 16 may also be positioned at an elevated position with respect to the coating chamber to facilitate flow of the coating solution into the coating chamber.

The present invention is more particularly described in the following example that is intended for illustrative purposes only and is not intended to limit the present invention in anyway.

### EXAMPLE

This Example was conducted to show that the apparatus of the present invention provides a satisfactory coating.

Coating Method

A 1 liter Platypus® bag (available from Cascade Designs, Seattle, Wash.) was charged with approximately 1000 mL of a 0.1% solution of PFPES-1 ((CH₃O)₃SiCH₂CH₂NHC(O)CF₂(CF₂O)₉₋₁₁(CF₂CF₂O)₉₋₁₁CF₂C(O) NHCH₂CH₂Si(OCH₃)₃) in HFE 7100 (C₄F₉OCH₃, perfluorobutyl methyl ether; Available from 3M Company, St. Paul, Minn.). PFPES-I was prepared by reacting perfluoropolyetherdiester CH₃OC(O)CF₂(CF₂O)₉₋₁₁(CF₂CF₂O)₉₋₁₁CF₂C(O)OCH₃ (with average molecular weight of about 2000; commercially available from Ausimont, Italy, under the trade designation FOMBLIN™ Z-DEAL) with 3-aminopropyltrimethoxysilane, (available from Aldrich Chemical, Inc. of Milwaukee, Wis.) as taught in U.S. Pat. No. 3,810,874 (Mitsch et al.), table 1, line 6. The exothermic reactions proceeded readily at room temperature, simply by mixing the materials. The progress of the reaction was monitored by infrared analysis.

The 1 liter Platypus® bag was attached to a bottom of a glass tank (8 inch (20.3 cm.) height×8 inch (20.3 cm.) width×1 inch (2.5 cm.) depth with the bottom of the glass tank sloping slightly towards the center) with a 6 ft (182.9 cm.) length of polypropylene tubing (3/8 inch (1.0 cm.) i.d.; available from W. W. Grainger, Inc. of Lake Forest, Ill.). The glass tank was utilized as the coating chamber. A glass microscope slide was suspended from the cover of the glass tank with an alligator clip. The glass tank was then covered. The Platypus® bag charged with PFPES-1 in HFE-7100 was raised just above the glass tank allowing the fluid from the bag to enter the glass tank. When the level of the PFPES-1 reached the top of the microscope slide, the Platypus® bag was then lowered below the bottom of the glass tank and placed in a horizontal position. The Platypus® bag was lowered approximately 32 inches (81.3 cm.) to obtain the desired drainage rate in relation to the amount of coating solution in the glass tank. The coating solution (PFPES-1) returned to the Platypus® bag at a rate of approximately 10 mm per second. A satisfactory coating of the glass slide occurred. The slide was then removed and allowed to cure at room temperature for about 3 weeks. The coated slide was then subjected to abrasion testing and contact angle measurements were taken on the abraded slides, both procedures described below.

Contact angle measurements were conducted in order to evaluate the repellency of the coated slide. Static water contact angle measurements were made using a Kruss G 10 Goniometer (Kruss U.S.A., Charlotte, N.C.). Deionized water was allowed to equilibrate for 1 minute prior to measurement. For each sample, 5 individual water drops were analyzed; average contact angles were calculated and are set forth in the FIG. 4. Contact angles having larger values indicate better repellency.

An abrasion test was done using a Gardco Model D12VF1 Wear Tester (Paul N. Garder Company, Incorporated, Pompano Beach, Fla.) using a 3M High Performance Cloth (3M Company, St. Paul, Minn.) and CIF Cleaner (Lever Faberge, Surrey, United Kingdom). Results of the abrasion studies are illustrated in FIG. 4. A contact angle of 75° or better is indicative of a satisfactory coating.

Although the present invention has been described with reference to preferred embodiments, workers skilled in the art will recognize that changes may be made in form and detail without departing from the spirit and scope of the invention.

1. An apparatus for coating a workpiece with a coating solution, the apparatus comprising:
a coating chamber in which the workpiece is coated;
a deformable coating solution supply container for supplying the coating solution to the coating chamber; and
a fluid connection fluidly connecting the coating chamber and the deformable coating solution supply container such that the coating solution is flowable between the coating chamber and the deformable coating solution supply container.

2. The apparatus of claim 1 wherein the deformable coating solution supply container is constructed for deformation by manual manipulation.

3. The apparatus of claim 1 wherein the deformable container is positionable to a first elevation in relation to the coating chamber that results in the coating solution flowing into the coating chamber.

4. The apparatus of claim 3 wherein the deformable coating solution supply container is positionable to a second elevation that results in the coating solution flowing from the coating chamber to the deformable coating solution supply container.

5. The apparatus of claim 1 and further including a mechanism that deforms the coating solution supply container to provide motive force to move the coating solution to the coating chamber and which permits the coating solution to flow back to the deformable coating supply container.

6. The apparatus of claim 5 wherein the mechanism includes a holding chamber for holding the deformable coating supply container and into which fluid pressure is supplied and applied to the deformable coating supply container to force the coating solution to flow from the container to the coating chamber, and wherein the coating solution is permitted to flow from the coating chamber to the deformable coating supply container by a decrease of fluid pressure.

7. The apparatus of claim 5 wherein the mechanism includes a plate for applying a force to an exterior surface of the deformable container to force the coating solution from the container to the coating chamber, the plate being retractable such that the coating solution flows back to the container from the coating chamber.

8. The apparatus of claim 1 and further including a valving mechanism that cooperates with the fluid connection to regulate flow from the coating chamber to the coating supply container.

9. An apparatus for coating a workpiece with a coating solution, the apparatus comprising:
a coating chamber in which the workpiece is coated;
a supply container for supplying the coating solution to the coating chamber and being reducible in volume; and
a fluid connection fluidly connecting the coating chamber and the supply container such that the coating solution is flowable between the coating chamber and the coating supply solution container.

10. The apparatus of claim 9 wherein the supply container is constructed for reduction in volume by manual manipulation.

11. The apparatus of claim 9 wherein the supply container is positionable to a first elevation in relation to the coating chamber that results in the coating solution flowing to the coating chamber.

12. The apparatus of claim 11 wherein the supply container is positionable to a second elevation that results in the coating solution flowing from the coating chamber to the coating solution supply container.

13. The apparatus of claim 11 and further including a mechanism that reduces in volume the supply container to provide motive force to move the coating solution to the coating chamber and which permits the coating solution to flow back to the coating solution supply container.

14. The apparatus of claim 13 wherein the mechanism includes a chamber for holding the supply container into which fluid pressure is supplied and applied to the coating solution supply container to force the coating solution to flow from the bag to the coating chamber, and wherein the coating solution is permitted to flow from the coating chamber to the supply container by a decrease of fluid pressure.

15. The apparatus of claim 13 wherein the mechanism includes a plate for applying a force to the exterior of the supply container to force the coating solution from the supply container, the plate being retractable such that the coating solution flows back to the supply container from the coating chamber.

16. The apparatus of claim 9 and further including a valving mechanism that cooperates with the fluid connection to regulate flow from the coating chamber to the coating supply container.

17. An apparatus for coating a workpiece with a coating solution, the apparatus comprising:
a coating chamber in which the workpiece is coated;
a collapsible coating solution supply container for supplying the coating solution to the coating chamber; and
a fluid connection fluidly connecting the coating chamber and the collapsible coating solution supply bag such that the coating solution is flowable between the coating chamber and the collapsible coating solution supply bag.

18. The apparatus of claim 17 wherein the collapsible coating solution supply bag is constructed for deformation by manual manipulation.

19. The apparatus of claim 17 wherein the collapsible coating solution supply container is positionable to a first elevation in relation to the coating chamber that results in the coating solution flowing to the coating chamber.

20. The apparatus of claim 19 wherein the collapsible coating solution supply container is positionable to a second elevation that results in the coating solution flowing from the coating chamber to the collapsible coating solution supply container.

21. The apparatus of claim 17 and further including a mechanism that collapses the collapsible coating supply container to provide motive force to move the coating solution to the coating chamber and which permits the coating solution to flow back to the collapsible coating solution supply container.

22. The apparatus of claim 21 wherein the mechanism includes a chamber for holding the collapsible coating solution supply container into which fluid pressure is supplied and applied to the collapsible coating supply container to force coating solution to flow from the bag to the coating chamber, and wherein the coating solution is permitted to flow from the coating chamber to the collapsible coating solution supply container by a decrease of pressure.

23. The apparatus of claim 21 wherein the mechanism includes a plate for applying a force to an exterior surface of the collapsible container to force coating solution from the container to the coating chamber, the plate being retractable such that the coating solution flows back to the container from the coating chamber.

24. The apparatus of claim 17 and further including a valving mechanism that cooperates with the fluid connection to regulate flow from the coating chamber to the collapsible supply container.

25. An apparatus for coating a workpiece with a coating solution, the apparatus comprising:
a coating chamber in which the workpiece is placed for coating;
a hermetically sealed deformable supply container for supplying the coating solution to the coating chamber; and
a fluid connection fluidly connecting the coating chamber and the hermetically sealed supply container such that the coating solution flows between the coating chamber and the hermetically sealed supply container.

26. The apparatus of claim 25 wherein the hermetically sealed coating supply container is constructed for deformable by manual manipulation.

27. The apparatus of claim 25 wherein the hermetically sealed supply container is positionable to a first elevation in relation to the coating chamber that results in the coating solution flowing to the coating chamber.

28. The apparatus of claim 27 wherein the hermetically sealed supply container is positionable to a second elevation that results in the coating solution flowing from the coating chamber to the hermetically sealed coating solution supply bag.

29. The apparatus of claim 25 and further including a mechanism that provides motive force to move the coating solution to the coating chamber and which permits the coating solution to flow back to the hermetically sealed supply container.

30. The apparatus of claim 25 and further including a valving mechanism that cooperates with the fluid connection to regulate flow from the coating chamber to the hermetically sealed supply container.

31. The apparatus of claim 29 wherein the mechanism further includes a chamber for holding the hermetically sealed coating supply solution container into which fluid pressure is supplied and applied to the hermetically sealed supply container to force the coating solution to flow from the container to the coating chamber, and wherein the coating solution is permitted to flow from the coating chamber to the hermetically sealed coating solution supply container by decrease of fluid pressure.

32. The apparatus of claim 25 wherein the mechanism includes a plate for applying a force to the exterior of the hermetically sealed supply container to force the coating solution from the container, the plate being retractable such that the coating solution flows back to the container from the coating chamber.

33. A kit for providing a coating to a workpiece, the kit comprising:
a hermetically sealed coating solution container;
a coating solution;
a coating chamber in which the workpiece is coated; and
a fluid connection fluidly connecting the coating chamber with the hermetically sealed coating solution container.

34. The kit of claim 33 wherein the coating solution is disposed within the hermetically sealed coating solution container.

35. The kit of claim 33 wherein the hermetically sealed coating solution container is a deformable container.

36. The kit of claim 33 wherein the hermetically sealed coating solution container is collapsible.

37. The kit of claim 33 wherein the hermetically sealed coating solution container is reducible in volume.

38. The kit of claim 33 and further including a valving mechanism that cooperates with the fluid connection.
